(19) United States
(12) Patent Application Publication
(10) Pub. No.: US 2026/0075354 A1
(43) Pub. Date: Mar. 12, 2026

(54) DYNAMIC-AND-FLAT COMBINATION HEADSET

(71) Applicant: HIFIMAN KUNSHAN TECHNOLOGY GROUP CO., LTD, Kunshan (CN)

(72) Inventors: Fang BIAN, Kunshan (CN); Zhijie ZHUANG, Kunshan (CN)

(21) Appl. No.: 19/197,835

(22) Filed: May 2, 2025

(30) Foreign Application Priority Data
Sep. 9, 2024 (CN) 202411255191.6

(51) Int. Cl. H04R 1/24; G06F 3/16; H04R 1/10; H04R 1/28; H04R 3/04; H04R 3/14

(52) U.S. Cl. CPC H04R 1/24; G06F 3/162; H04R 1/1008; H04R 1/1041; H04R 1/1075; H04R 1/288; H04R 1/2896; H04R 3/04; H04R 3/14

(57) ABSTRACT

The present disclosure relates to a dynamic-and-flat combination headset, where a dynamic speaker is used as a bass unit and a flat speaker is used as a mid-high frequency unit. By positioning an axial direction of the flat speaker and an axial direction of the dynamic speaker in a non-collinear arrangement, and preferably perpendicular to each other. An acoustic interference between the two driver units is effectively reduced, improving sound clarity and positional accuracy. An installation of a sound-absorbing material within a housing significantly decreases resonance and distortion caused by internal sound wave reflections, enhancing overall audio quality. A configuration of an active crossover and a crossover adjuster ensures a smooth transition between the flat speaker and the dynamic speaker, achieving a precise frequency division. An open design of the dynamic speaker not only improves a bass response but also enhances overall comfort. The present disclosure provides excellent sound performance and a comfortable wearing experience, suitable for applications such as music production, monitoring, and high-quality audio enjoyment.

### CROSS-REFERENCE TO RELATED APPLICATION

The present disclosure claims priority to Chinese Patent Application No. 202411255191.6 filed on Sep. 9, 2024, which is incorporated herein by reference in its entirety.

### TECHNICAL FIELD

The present disclosure relates to the field of headset technology, and specifically to a dynamic-and-flat combination headset.

### BACKGROUND

With continuous advancements in audio technology, consumer demand for high-quality audio experiences has been steadily increasing. Particularly in the field of headsets, users not only seek portability and comfort but are also increasingly focused on sound fidelity and detail. To meet these demands, various types of headsets have emerged in the market, among which coaxial flat speaker technology has gained attention for its unique design and excellent sound quality performance.

Coaxial flat speaker technology achieves a more natural and harmonious sound performance by coaxially arranging speakers that are responsible for different frequency ranges. This technology not only enhances the consistency of sound quality but also deepens the sound's depth, improving the full-range performance of headsets to achieve high standards of audio quality.

For example, JP2023002893U proposes a noise-canceling headset with a coaxial flat speaker, where a first dynamic speaker responsible for mid-low frequency vibrations and a flat speaker or second dynamic speaker responsible for mid-high frequency vibrations are coaxially mounted within the headset body. This configuration enhances sound consistency and depth, improving the headset's full-range performance.

Similarly, CN217721475U discloses a dual-unit module of dynamic-and-flat speakers, comprising a first housing and a second housing, with the second housing connected to the front surface of the first housing. The rear surfaces of the first and second housings respectively are provided a first cavity and a second cavity, with the two cavities in communication. A dynamic bass speaker is installed in the first cavity, and a flat tweeter is installed in the second cavity, providing an acoustic speaker that balances both low and high frequencies.

Despite the achievements made with coaxial flat speaker technology, it still faces certain challenges and shortcomings. For instance, in some designs, coaxially arranged speakers may encounter issues with sound consistency, particularly in achieving smooth transitions between different frequency ranges, which may affect the coherence and naturalness of the sound quality. Additionally, due to the limited internal space in headsets, sound waves reflecting within the enclosure may lead to resonance and distortion, impacting overall audio quality. Current coaxial flat speaker headsets on the market often lack the capability to automatically adjust sound settings based on a user's hearing characteristics, which limits the headset's ability to provide a highly personalized listening experience.

### SUMMARY

In order to solve the above problems, the present disclosure provides a dynamic-and-flat combination headset, including a housing, a flat speaker, and a dynamic speaker, wherein an axial direction of the flat speaker and an axial direction of the dynamic speaker are not aligned on the same straight line.

In this configuration, the dynamic speaker is used as a bass unit, and the flat speaker is used as a mid-high frequency unit; and a crossover frequency is 400 Hz, wherein the dynamic speaker emits a sound with frequencies below the crossover frequency 400 Hz, and wherein the flat speaker emits a sound with frequencies above the crossover frequency 400 Hz.

A spatial straight line A represents the axial direction of the flat speaker, and a spatial straight line B represents the axial direction of the dynamic speaker. An angle θ represents a smallest angle between spatial straight line A and spatial straight line B, wherein 45°≤θ≤90°.

The axial direction of the flat speaker and the axial direction of the dynamic speaker are perpendicular to each other spatially.

The flat speaker is installed inside the housing through a flat speaker pad, while the dynamic speaker is directly mounted on the housing.

The flat speaker includes a main body and a vibration-damping ring of the flat speaker, wherein the main body of the flat speaker is mounted on the vibration-damping ring, and the vibration-damping ring is connected to the flat speaker pad. The vibration-damping ring has an openwork structure, allowing sound waves emitted by the dynamic speaker to pass through the openwork structure of the vibration-damping ring.

A sound-absorbing material is installed at a position on the housing corresponding to the axial direction of the flat speaker, so that a sound emitted from a side of the flat speaker away from a human ear is largely absorbed by the sound-absorbing material. Additionally, a sound emitted by the dynamic speaker that reflects off the housing and passes through the main body of the flat speaker is further largely absorbed by the sound-absorbing material.

The parameters of the sound-absorbing material are as follows.
Sound absorption coefficient: 0.85 to 0.95 at a frequency of 1 kHz, 0.45 to 0.50 at a frequency of 250 Hz;
Density: 12 to 16 kg/m³;
Thickness: 5 to 8 mm;
Acoustic impedance: 250 to 350 N·s/m³.

The vibration-damping ring is made of rubber or silicone material, and its parameters are as follows.
Damping coefficient: 0.2 to 0.25;
Hardness: Shore A 45 to 50;
Thickness: 1.5 to 2 mm;
Elastic modulus: 0.7 to 1 MPa;

Area of an openwork portion of the vibration-damping ring accounts for more than 60% of a total area thereof.

The present disclosure further includes an active crossover, a crossover adjuster, and an interface; the interface comprises an audio interface and a digital interface, wherein the digital interface is connected to a decoder, and the decoder is connected to the active crossover; the audio interface is connected to the active crossover.

The active crossover includes a preamplifier and a power amplifier with power amplification functionality; the active crossover is connected to the flat speaker and the dynamic speaker, with the flat speaker used for mid-high frequency output and the dynamic speaker used for bass output. The crossover adjuster is connected to the active crossover to adjust the frequency division point of the crossover.

The active crossover is provided as follows.
Frequency division point: initially set at 400 Hz;
Filter configuration: uses a Butterworth filter;

A second-order high-pass Butterworth filter is connected to the flat speaker, and a second-order low-pass Butterworth filter is connected to the dynamic speaker. A variable resistor is used to adjust the frequency division point, and the crossover adjuster changes the frequency division point by adjusting the variable resistor;

Phase compensation: a capacitor is added to a path of a driver after the high-pass filter to ensure consistent phase response near the frequency division point;

a resistor is provided to adjust an impedance of each driver so that the impedance of each driver matches the output impedance of the headset.

A ratio of a diameter of the flat driver unit to a diameter of the dynamic driver unit is between 1.2:1 and 1.5:1.

The dynamic speaker is designed with an open structure, with the back of the dynamic speaker positioned outside the headset, allowing the sound emitted by the dynamic speaker to propagate freely from the back, thereby reducing internal sound wave reflections and minimizing resonance and distortion.

A microprocessor is provided within the crossover adjuster, and the microprocessor is connected to the active crossover, and is capable of adjusting the crossover parameters according to hearing data input by the user via a control panel on the headset or a paired application. The microprocessor includes a built-in calibration algorithm that automatically adjusts sound settings based on the user's hearing characteristics, optimizing frequency and phase responses to ensure balanced sound. The user can select a preset sound mode through the control panel or application and manually adjust the frequency division point.

The flat speaker pad is provided with a connector for the flat speaker, the housing, and the car cover; wherein the flat speaker and the housing are mounted on one side of the flat speaker pad, and the car cover is mounted on the other side of the flat speaker pad. The housing includes a pair of two housings, and either housing is fixedly provided with the flat speaker and the dynamic speaker, and a headband assembly is arranged between the two housings.

The beneficial effects of the present disclosure are as follows.

The present disclosure provides a dynamic-and-flat combination headset, in which the axial directions of the flat speaker (4) and the dynamic speaker (2) are set to be non-collinear, and preferably perpendicular to each other. This configuration effectively reduces acoustic interference between the two driver units, thereby enhancing sound clarity and positional accuracy.

By installing a sound-absorbing material inside the housing (1), resonance and distortion caused by internal sound wave reflections are significantly reduced, thus improving overall sound quality. The use of a vibration-damping ring further reduces the vibrations of the flat speaker (4), enhancing the purity of the sound.

The vibration-damping ring is designed with an openwork structure, which effectively reduces vibrations generated by the flat speaker (4) during operation, thereby minimizing sound distortion. The openwork design allows sound waves emitted by the dynamic speaker (2) to pass smoothly through the vibration-damping ring, avoiding the sound wave reflections and diffractions that would otherwise occur due to obstruction by the ring, further reducing sound distortion. In addition, the openwork structure helps improve airflow within the headset, promoting even sound diffusion and enhancing overall sound quality. Therefore, the design of the openwork vibration-damping ring contributes to the overall sound performance of the headset, particularly in enhancing sound clarity and reducing distortion.

The configuration of the active crossover and the crossover adjuster ensures a smooth transition between the flat speaker (4) and the dynamic speaker (2), achieving a precise frequency division. In particular, the microprocessor is provided within the crossover adjuster, enabling automatic sound adjustment based on the user's hearing data, thereby providing a highly personalized auditory experience. The open design of the dynamic speaker (2) not only enhances bass response but also improves overall comfort. Overall, the present disclosure delivers exceptional sound performance and a comfortable wearing experience, making it particularly suitable for applications such as music production, monitoring, and high-quality audio enjoyment.

By adding a capacitor to the path of the driver after the high-pass filter, consistent phase response near the frequency division point is ensured, achieving phase alignment between the flat speaker (4) and the dynamic speaker (2). This phase alignment helps to ensure consistent phase response between the two driver units around the frequency division point, thereby improving sound imaging accuracy and overall sound coherence. This is crucial for enhancing the overall sound quality and listening experience of the headsets, especially in multi-channel audio playback, where it enables a more natural and realistic sound reproduction. Thus, by implementing precise phase alignment, the present disclosure significantly enhances audio quality, providing users with a more immersive listening experience.

By setting the ratio of the diameter of the flat driver unit to the diameter of the dynamic driver unit as between 1.2:1 and 1.5:1, the present disclosure effectively optimizes the sound performance of the headsets. This diameter ratio design ensures good matching of frequency response and acoustic characteristics between the flat and dynamic driver units, enhancing sound coherence and balance. Typically, the flat driver unit handles mid-high frequencies, while the dynamic driver unit covers the low frequencies. A well-chosen diameter ratio facilitates a smooth transition between the flat and dynamic driver units, avoiding noticeable gaps or abrupt changes in sound. Therefore, by implementing an appropriate diameter ratio, the present disclosure provides a more natural, balanced, and rich sound experience, making it particularly suitable for applications focused on high-quality audio playback.

### BRIEF DESCRIPTION OF THE DRAWINGS

In order to explain the embodiments of the present disclosure or the technical solutions in the prior art more clearly, a brief description will be given below with reference to the accompanying drawings which are used in the description of the embodiments or the prior art and it is obvious that the drawings in the description below are only some embodiments of the present disclosure, and it would be obvious for a person skilled in the art to obtain other drawings according to these drawings without involving any inventive effort.

FIG. 1 is an appearance view of the headset according to the present disclosure;

FIG. 2 is an exploded view of the structure of the headset according to the present disclosure;

FIG. 3 is a side cross-sectional view of the headset according to the present disclosure; and

FIG. 4 is a schematic structural diagram of the headset according to the present disclosure.

Wherein: 1—housing, 2—dynamic speaker, 3—interface, 4—flat speaker, 5—flat speaker pad, 6—ear cover, 7—headband assembly.

### DETAILED DESCRIPTION

### Embodiment 1

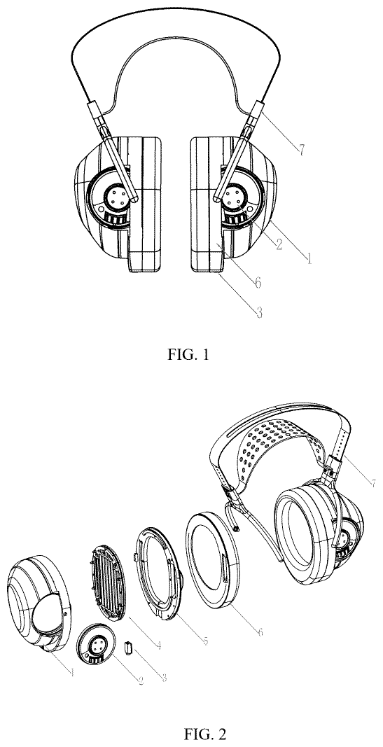

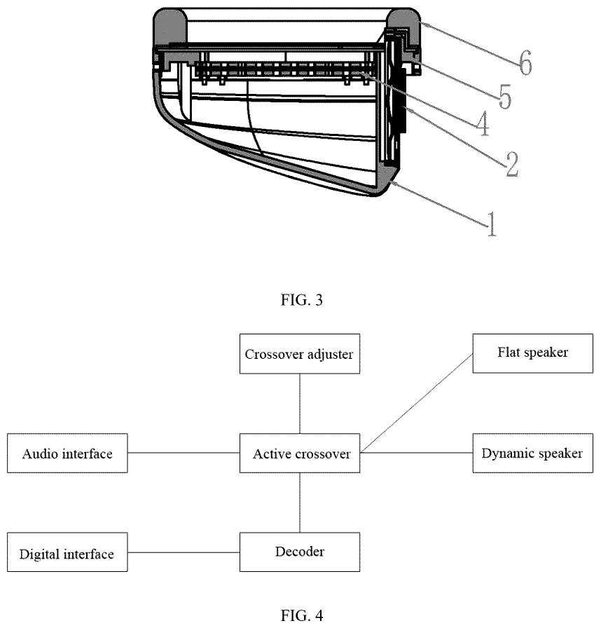

Referring to FIGS. 1-4, the present disclosure provides a dynamic-and-flat combination headset, comprising a housing 1, a flat speaker 4, and a dynamic speaker 2, an axial direction of the flat speaker 4 and an axial direction of the dynamic speaker 2 are not aligned on the same straight line.

Preferably, a spatial straight line A represents the axial direction of the flat speaker 4, and a spatial straight line B represents the axial direction of the dynamic speaker 2, with an angle θ representing a smallest angle between spatial straight line A and spatial straight line B; thus, 45°≤θ≤90°.

More preferably, the axial directions of the flat speaker 4 and the dynamic speaker 2 are perpendicular to each other spatially.

The flat speaker 4 is installed inside the housing 1 through a flat speaker pad 5, while the dynamic speaker 2 is directly mounted on the housing 1.

The flat speaker 4 includes a main body and a vibration-damping ring of the flat speaker 4, wherein the main body of the flat speaker 4 is mounted on the vibration-damping ring, and the vibration-damping ring is connected to the flat speaker pad 5. The vibration-damping ring has an openwork structure, allowing sound waves emitted by the dynamic speaker 2 to pass through the openwork structure of the vibration-damping ring.

A sound-absorbing material is installed at a position on the housing 1 corresponding to the axial direction of the flat speaker 4 so that a sound emitted from a side of the flat speaker 4 facing away from a human ear is largely absorbed by the sound-absorbing material. Simultaneously, a sound emitted by the dynamic speaker 2 that reflects off the housing 1 and passes through the main body of the flat speaker 4 is further largely absorbed by the sound-absorbing material.

The parameters of the sound-absorbing material are as follows.
Sound absorption coefficient: 0.85 to 0.95 at a frequency of 1 kHz, 0.45 to 0.50 at a frequency of 250 Hz;
Density: 12 to 16 kg/m³;
Thickness: 5 to 8 mm;
Acoustic impedance: 250 to 350 N·s/m³.

The vibration-damping ring is made of rubber or silicone material, with the following parameters:
Damping coefficient: 0.2 to 0.25;
Hardness: Shore A 45 to 50;
Thickness: 1.5 to 2 mm;
Elastic modulus: 0.7 to 1 MPa;

The openwork portion of the vibration-damping ring accounts for more than 60% of the total area.

The headset further includes an active crossover, a crossover adjuster, and an interface 3. The interface 3 includes an audio interface and a digital interface, with the digital interface connected to a decoder and the decoder connected to the active crossover; the audio interface is also connected to the active crossover.

The active crossover includes a preamplifier and a power amplifier with power amplification functionality. The active crossover is connected to the flat speaker 4 and the dynamic speaker 2, with the flat speaker 4 responsible for mid-high frequency output and the dynamic speaker 2 for bass output. The crossover adjuster is connected to the active crossover for adjusting the frequency division point of the crossover.

The active crossover is provided as follows.
Frequency division point: initially set at 400 Hz;
Filter configuration: uses a Butterworth filter;

A second-order high-pass Butterworth filter is connected to the flat speaker 4, and a second-order low-pass Butterworth filter is connected to the dynamic speaker 2. A variable resistor is used to adjust the frequency division point, with the crossover adjuster changing the frequency division point by adjusting the variable resistor;

Phase compensation: a capacitor is added to a path of a driver after the high-pass filter to ensure consistent phase response near the frequency division point;

a resistor is provided to adjust an impedance of each driver so that the impedance of each driver matches the output impedance of the headset.

A ratio of a diameter of the flat driver unit to a diameter of the dynamic driver unit can be considered to be between 1.2:1 and 1.5:1.

The dynamic speaker 2 is designed with an open structure, with the back of the dynamic speaker 2 positioned outside the headset, allowing the sound emitted by the dynamic speaker 2 to propagate freely from the back. This design reduces internal sound wave reflections, thereby minimizing resonance and distortion.

A microprocessor is provided within the crossover adjuster, and the microprocessor is connected to the active crossover, and is capable of adjusting the crossover parameters based on hearing data input by the user through a control panel on the headset or a paired application. The microprocessor includes a built-in calibration algorithm that automatically adjusts sound settings according to the user's hearing characteristics, optimizing frequency and phase responses to ensure balanced sound. Users can select a preset sound mode and manually adjust the frequency division point via the control panel or application.

The flat speaker pad 5 is provided with a connector for the flat speaker 4, the housing 1, and the car cover 6; wherein the flat speaker 4 and the housing 1 are mounted on one side of the flat speaker pad 5, and the car cover 6 is mounted on the other side of the flat speaker pad 5. The housing 1 includes a pair of two housings, and either housing is fixedly provided with the flat speaker 4 and the dynamic speaker 2, and a headband assembly 7 is positioned between the two housings 1.

### Embodiment 2

This embodiment tests the optimal angle range for the present invention's structure, based on the axial angles of the flat speaker 4 and the dynamic speaker 2.

The spatial straight line A represents the axial direction of the flat speaker 4, and the spatial straight line B represents the axial direction of the dynamic speaker 2. The angle θ represents a smallest angle between the spatial straight line A and the spatial straight line B.

### Experimental Materials:

headset prototype: a prototype of the dynamic-and-flat combination headset as described.
Test audio source: test audio files containing various frequency bands.
Spectrum analyzer: used to measure the frequency and phase responses of the headsets.
Subjective evaluation group: a group of professional audio engineers tasked with subjectively evaluating the sound performance of the headsets.

### Experimental Method

A series of headset prototypes were prepared, with each prototype set to a different angle θ between the axial directions of the flat speaker 4 and the axial directions of the dynamic speaker 2, ranging from 0° to 90°, with samples at 5° intervals. All other design parameters for the headset prototypes were kept constant, including the ratio of the diameter of the driver units to the diameter of the crossover parameters.

Frequency and Phase Response Testing: each prototype was tested for frequency and phase responses using the spectrum analyzer. Frequency response and phase response curves were recorded for each prototype at different angles.

Subjective Evaluation: the subjective evaluation group, consisting of professional audio engineers, assessed the listening experience of each prototype. Evaluation criteria included sound clarity, balance, and spatial imaging. Subjective evaluation results were recorded for each prototype.

### Data Analysis:

Statistical analysis was conducted on the frequency and phase response test data to determine trends in response changes at different angles. The subjective evaluation results were combined to analyze the impact of various angles on headset sound performance. The optimal angle range was determined.

### Experimental Results

The experimental results are shown in Table I.
Frequency Response: as the angle increases, the frequency response curve becomes smoother, particularly near the crossover frequency point.
Phase Response: when the angle is between 45° and 90°, the phase response curve is the flattest, indicating optimal phase alignment within this range.
Subjective Evaluation: the evaluation group observed that sound clarity, balance, and spatial imaging were optimal when the angle was between 45° and 90°.

TABLE I
Auditory Perception Changes with Different Angle Ranges

| Angle θ (°) | 0-10 | 15-25 | 30-40 | 45-60 | 65-80 |
|---|---|---|---|---|---|
| Frequency | Not Smooth | Gradually | More | Very | Very |
| Response | | Smooth | Smooth | Smooth | Smooth |
| Variation | | | | | |
| Phase Response | Significant | Reduced | Reduced | Well- | Excellent |
| Variation | Distortion | Distortion | Distortion | Aligned | Alignment |
| Subjective | Poor | Average | Good | Excellent | Excellent |
| Evaluation | | | | | |

### Embodiment 3

This embodiment tests different diameter ratios between the flat headsets and dynamic headsets to determine the optimal ratio range.

### Testing Method and Procedure

### Preparation Stage

Selection of Test Ratios: select typical ratios for testing, including 1.2:1, 1.3:1, 1.4:1, and 1.5:1.
Prototype Creation: create headset prototypes based on the selected ratios.

### Testing Equipment

Acoustic Testing Equipment: sound level meter, spectrum analyzer, headset testing bench, etc.
Simulation Software: professional acoustic simulation software such as EARS and FIR Designer.

### Testing Steps

Acoustic Simulation: use simulation software to model the acoustic performance of headsets with different ratios. Record key indicators such as frequency response, phase response, and distortion.
Laboratory Testing: place the headset prototypes on the headset testing bench. Use a sound level meter and spectrum analyzer to measure frequency response, phase response, distortion, and sound pressure level. Record the test data.
User Listening Test: select a group of testers for listening evaluations, collecting subjective assessments. The testers include both professionals and regular users. Record user feedback on listening experience.
Data Analysis: perform statistical analysis on all test data, including calculations of mean values and standard deviations. Analyze performance differences of the headsets under different ratios. Determine the optimal ratio based on a combination of objective data and user feedback.

TABLE II
Objective Test Results

| | Average | | Average | Average |
|---|---|---|---|---|
| | Frequency | Average Phase | Distortion | Sound Pressure |
| Ratio | Response (dB) | Response (°) | (%) | Level (dB SPL) |
| 1.2:1 | 0.5 | 5 | 0.8 | 102 |
| 1.3:1 | 0.3 | 3.5 | 0.6 | 103 |
| 1.4:1 | 0.4 | 4.2 | 0.7 | 101 |
| 1.5:1 | 0.6 | 6.1 | 0.9 | 100 |

TABLE III
User Listening Feedback

| | | | Mid-High | |
|---|---|---|---|---|
| | User | Bass | Frequency | |
| | Satisfaction | Performance | Performance | Comfort |
| Ratio | (1-5) | (1-5) | (1-5) | (1-5) |
| 1.2:1 | 4 | 4 | 4.5 | 4.2 |
| 1.3:1 | 4.5 | 4.5 | 4.8 | 4.5 |
| 1.4:1 | 4.2 | 4.3 | 4.7 | 4.3 |
| 1.5:1 | 4 | 4.2 | 4.6 | 4.1 |

Based on the test results, the ratio of 1.3:1 performed exceptionally well in both objective testing and user listening feedback. Specifically, it achieved optimal results in frequency response, phase response, distortion, and sound pressure level, while also receiving high user satisfaction ratings. Therefore, a ratio of 1.3:1 is determined to be the optimal diameter ratio between the flat driver unit and the dynamic driver unit.

### Embodiment 4

The present disclosure further tested the impact of the sound absorption coefficient of the sound-absorbing material on headset performance.

### Experimental Materials

headset Prototype: a dynamic-and-flat combination headset based on the previous design.
Sound-absorbing Material Samples: samples with various sound absorption coefficients.
Acoustic Testing Equipment: sound level meter, spectrum analyzer, headset testing bench, etc.
Simulation Software: acoustic simulation software for modeling headset performance.

### Experimental Steps

Preparation Stage: selection of Sound-absorbing Material Samples: Choose several representative samples within the specified sound absorption coefficient range (0.85˜0.95 at a frequency of 1 kHz).
Prototype Creation: create headset prototypes based on the previous design, ensuring that all parameters remain consistent except for the sound-absorbing material.

### Test Preparation

Installation of Sound-absorbing Material: install the different sound-absorbing material samples at positions on the housing corresponding to the axial direction of the flat speaker.
Test Environment Setup: ensure that the test environment meets standard acoustic testing conditions, such as a silent room or an anechoic chamber.

### Experimental Procedure

Acoustic Simulation: use acoustic simulation software to model the performance of headsets with different sound absorption coefficients. Record key indicators such as frequency response, phase response, distortion, and sound pressure level.
Laboratory Testing: place the headset prototypes on the headset test bench. Use a sound level meter and spectrum analyzer to measure frequency response, phase response, distortion, and sound pressure level. Record the test data.
Data Analysis: perform statistical analysis on all test data, including calculations of mean values and standard deviations. Analyze performance differences of the headsets under different sound absorption coefficients. Determine the optimal sound absorption coefficient range based on a combination of objective data.

TABLE IV
Objective Test Results

| | | Average | | |
|---|---|---|---|---|
| Sound | Average | Phase | Average | Average Sound |
| Absorption | Frequency | Response | Distortion | Pressure Level |
| Coefficient | Response (dB) | (°) | (%) | (dB SPL) |
| 0.85 | 0.6 | 5.2 | 0.9 | 102 |
| 0.90 | 0.4 | 4.1 | 0.7 | 103 |
| 0.95 | 0.3 | 3.5 | 0.6 | 104 |

Based on the experimental results, a sound absorption coefficient range of 0.90 to 0.95 yields satisfactory results, with a coefficient of 0.95 providing optimal performance in terms of frequency response, phase response, distortion, and sound pressure level. Therefore, the recommended sound absorption coefficient range is 0.90 to 0.95. Within this range, selecting a coefficient of 0.95 can result in better acoustic performance, including smoother frequency response, lower distortion, and higher sound pressure level.

The descriptions of the above embodiments are provided for the purpose of illustration and explanation. They are not intended to be exhaustive or to limit the present disclosure. Individual elements or features of specific embodiments are not limited to those particular embodiments but can be interchanged and used in selected embodiments where applicable, even if not specifically shown or described. In many respects, the same elements or features can be varied. Such variations are not to be regarded as a departure from the disclosure, and all such modifications are intended to be included within the scope of the present disclosure.

Example embodiments are provided so that this disclosure will be thorough and will fully convey the scope to those skilled in the art. Numerous details are set forth, such as examples of specific parts, devices, and methods, in order to provide a thorough understanding of the embodiments of the present disclosure. It will be apparent to those skilled in the art that specific details need not be used, that the example embodiments may be implemented in many different forms, and that neither should be construed to limit the scope of the present disclosure. In certain example embodiments, well-known procedures, well-known device structures, and well-known techniques are not described in detail.

Technical terminology is used herein solely for the purpose of describing particular exemplary embodiments and is not intended to be limiting. Unless explicitly stated otherwise, the singular forms “a” and “the” as used herein include plural referents as well. The terms “comprise” and “have” are inclusive, specifying the presence of stated features, elements, steps, operations, components, and/or assemblies, but do not preclude the presence or addition of one or more other features, elements, steps, operations, components, assemblies, and/or combinations thereof. Unless a specific sequence is indicated, the method steps, processes, and operations described herein are not to be construed as necessarily requiring performance in the order discussed or illustrated. It is also to be understood that additional or alternative steps may be employed.

What is claimed is:

1. A dynamic-and-flat combination headset, comprising a housing (1), a flat speaker (4), and a dynamic speaker (2), characterized in that an axial direction of the flat speaker (4) and an axial direction of the dynamic speaker (2) are not aligned on the same straight line;
the dynamic speaker is used as a bass unit, and the flat speaker is used as a mid-high frequency unit; and a crossover frequency is 400 Hz, wherein the dynamic speaker emits a sound with frequencies below the crossover frequency 400 Hz, and wherein the flat speaker emits a sound with frequencies above the crossover frequency 400 Hz.

2. The dynamic-and-flat combination headset according to claim 1, characterized in that: a spatial straight line A represents the axial direction of the flat speaker (4), a spatial straight line B represents the axial direction of the dynamic speaker (2), and an angle θ represents a smallest angle between the spatial straight line A and the spatial straight line B; wherein 45°≤θ≤90°.

3. The dynamic-and-flat combination headset according to claim 2, characterized in that: the axial direction of the flat speaker (4) and the axial direction of the dynamic speaker (2) are perpendicular to each other spatially.

4. The dynamic-and-flat combination headset according to claim 1, characterized in that: the flat speaker (4) is installed inside the housing (1) through a flat speaker pad (5), and the dynamic speaker (2) is directly mounted on the housing (1);
the flat speaker (4) comprises a main body and a vibration-damping ring of the flat speaker (4), wherein the main body of the flat speaker (4) is mounted on the vibration-damping ring, and the vibration-damping ring is connected to the flat speaker pad (5); the vibration-damping ring has an openwork structure, allowing sound waves emitted by the dynamic speaker (2) to pass through the openwork structure of the vibration-damping ring;
a sound-absorbing material is installed at a position on the housing (1) corresponding to the axial direction of the flat speaker (4), so that a sound emitted from a side of the flat speaker (4) away from a human ear is largely absorbed by the sound-absorbing material; simultaneously, a sound emitted by the dynamic speaker (2) that reflects off the housing (1) and passes through the main body of the flat speaker (4) is further largely absorbed by the sound-absorbing material.

5. The dynamic-and-flat combination headset according to claim 4, characterized in that:
parameters of the sound-absorbing material are as follows:
a sound absorption coefficient: 0.85 to 0.95 at a frequency of 1 kHz, 0.45 to 0.50 at a frequency of 250 Hz;
a density: 12 to 16 kg/m³;
a thickness: 5 to 8 mm;
an acoustic impedance: 250 to 350 N·s/m³;
the vibration-damping ring is made of rubber or silicone material, and the parameters of the vibration-damping ring are as follows:
a damping coefficient: 0.2 to 0.25;
a hardness: Shore A 45 to 50;
a thickness: 1.5 to 2 mm;
an elastic modulus: 0.7 to 1 MPa;
an area of an openwork portion of the vibration-damping ring accounts for more than 60% of a total area thereof.

6. The dynamic-and-flat combination headset according to claim 4, characterized in that:
further comprises an active crossover, a crossover adjuster, and an interface (3); the interface (3) comprises an audio interface and a digital interface, wherein the digital interface is connected to a decoder, and the decoder is connected to the active crossover; the audio interface is connected to the active crossover;
the active crossover comprises a preamplifier and a power amplifier with power amplification functionality; the active crossover is connected to the flat speaker (4) and the dynamic speaker (2), wherein the flat speaker (4) is used for mid-high frequency output, and the dynamic speaker (2) is used for bass output; the crossover adjuster is connected to the active crossover to adjust the frequency division point of the crossover;
the active crossover is provided as follows:
a frequency division point: initially set at 400 Hz;
a filter configuration: uses a Butterworth filter;
a second-order high-pass Butterworth filter is connected to the flat speaker (4), a second-order low-pass Butterworth filter is connected to the dynamic speaker (2), and a variable resistor is used to adjust the frequency division point; the crossover adjuster changes the frequency division point by adjusting the variable resistor;
phase compensation: a capacitor is added to a path of a driver after the high-pass filter, ensuring a consistent phase response near the frequency division point;
a resistor is provided to adjust an impedance of each driver so that the impedance of each driver matches the output impedance of the headset.

7. The dynamic-and-flat combination headset according to claim 4, characterized in that: a ratio of a diameter of the flat driver unit to a diameter of the dynamic driver unit is between 1.2:1 and 1.5:1.

8. The dynamic-and-flat combination headset according to claim 4, characterized in that:
the dynamic speaker (2) has an open design, wherein a back of the dynamic speaker (2) located outside the headset, allowing the sound emitted by the dynamic speaker (2) to propagate freely from the back, reducing internal sound wave reflections and thereby reducing resonance and distortion.

9. The dynamic-and-flat combination headset according to claim 6, characterized in that:
a microprocessor is provided within the crossover adjuster, and the microprocessor is connected to the active crossover, and is capable of adjusting the crossover parameters according to a hearing data input by the user via a control panel on the headset or a paired application program; the microprocessor includes a built-in calibration algorithm, which automatically adjusts sound settings based on the user's hearing characteristics, optimizing frequency and phase responses to ensure sound balance; the user can select a preset sound mode and manually adjust the frequency division point via the control panel or the application program.

10. The dynamic-and-flat combination headset according to claim 6, characterized in that:
the flat speaker pad (5) comprises a connector for the flat speaker (4), the housing (1), and the ear cover (6); wherein the flat speaker (4) and the housing (1) are mounted on one side of the flat speaker pad (5), and the ear cover (6) is mounted on the other side of the flat speaker pad (5); the housing (1) comprises a pair of two housings, and either housing is fixedly provided with the flat speaker (4) and the dynamic speaker (2), and a headband assembly (7) is arranged between the two housings (1).
